(19) United States
(12) Patent Application Publication
(10) Pub. No.: US 2006/0114944 A1
(43) Pub. Date: Jun. 1, 2006

(54) Apparatus and method for measuring a delay in the transmission of multimedia data in a multimedia system

(75) Inventors: Sang-Ho Kim, Hwaseong-si (KR); Jae-Hun Cho, Seoul (KR); Jun-Ho Koh, Suwon-si (KR); Yun-Je Oh, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/290,410

(22) Filed: Nov. 30, 2005

(30) Foreign Application Priority Data
Nov. 30, 2004 (KR) 2004-99564

(51) Int. Cl. H04J 3/06

(52) U.S. Cl. 370/516

(57) ABSTRACT

Disclosed are a method and an apparatus for quantitatively measuring a delay caused according to communication environments during a transmission of multimedia data, particularly, MPEG (Moving Picture Experts Group)-2 TS (Transport Stream), in a multimedia system. The apparatus includes a transmitter that generates and transmits a counter information packet (CIP), which is required to measure the delay in the transmission of the multimedia data, by inserting into the multimedia data the results of counting predetermined bits using a first counter; and a receiver that receives the CIP and computes the delay by comparing the counting results in the CIP with counting results received from a second counter.

### CLAIM OF PRIORITY

This application claims priority to an application entitled “Apparatus and Method for Measuring a Delay in Transmission of Multimedia Data in A Multimedia Data Transmitting and Receiving System” filed in the Korean Intellectual Property Office on Nov. 30, 2004 and assigned Ser. No. 2004-99564, the contents of which are hereby incorporated by reference.

### BACKGROUND OF THE INVENTION

1. Field of the Invention

The present invention relates generally to an apparatus for transmitting and receiving multimedia data, and more particularly to a method and an apparatus for quantitatively measuring a delay in the transmission of an MPEG (Moving Picture Experts Group)-2 TS(Transport Stream).

2. Description of the Related Art

It is well known that multimedia data is transmitted from a transmitter to a receiver in the form of an MPEG-TS. Transmission of data in the form of an MPEG-TS may be delayed according to the environment of a digital communication system or by a system error for a predetermined variable length of time. However, when isochronous data is transmitted, calibration of a delay in the data transmission is a significant factor that determines the quality of service (QoS). To maintain the QoS, the timing between a transmitter and a receiver of a digital communication system must be accurately maintained. Otherwise, it is difficult to control the quality of the audio/video data to be input to the receiver at a desired level.

Accordingly, accurate timing between the receiver and the transmitter is required for transmission of a digital audio/video signal encoded in the MPEG (Moving Picture Experts Group) standard. In general, a bit clock signal output from an MPEG decoder must be transmitted at the same speed as a bit clock signal output from an encoder, which encodes data according to the MPEG standard being transmitted. Therefore, the MPEG standard prescribes that an encoder (transmitter) include a time stamp known as a program clock reference (PCR) or a system clock reference (SCR) into several packets of MPEG data. A decoder (receiver) detects and interprets the PCR or the SCR, and transmits an internal clock for controlling the speed of receivied MPEG data using the PCR or the SCR.

The accurate timing may be maintained by transmitting multimedia data from the transmitter at the same speed that the receiver receives the multimedia data, so that the receiver can process it according to a real-time application. Also, the duration of all multimedia data that are transmitted via a digital communication system must be equalized.

However, apart from the maintenance of timing between the transmitter and the receiver for synchronization of multimedia data, the difference between the time that a digital broadcasting signal is transmitted and the time that the digital broadcasting signal is received may occur when a digital broadcasting service, e.g., time information, is provided through broadcasting. A method of precisely measuring the time difference in order to compensate for the time difference has yet to be developed.

FIG. 1 illustrates an example of the construction of a multimedia data transmitting and receiving system. As shown, the system includes a camera 11 that generates a broadcasting signal, a transmitter 12 that transforms the broadcasting signal received from the camera 11 into an MPEG-2 TS and transmits the MPEG-2 TS, a receiver 14 that receives the MPEG-2 TS and inversely transforms it into the broadcasting signal and outputs the broadcasting signal, and a network 13 that connects the transmitter 12 to the receiver 14.

If the time that the broadcasting signal is received from the camera 11 is t, the time that the receiver 14 receives the broadcasting signal is t+Δt considering a delay Δt caused by the transmitter 12, the network 13, and the receiver 14.

Accordingly, even when a service with the desired QoS level is provided by the synchronizing transmission of digital broadcasting signal, it causes a difference between the time t that the digital broadcasting signal is received and the time t+Δt that the digital broadcasting signal is actually broadcast. Such a time difference may cause problems in providing an alarm service or sports relay broadcasting. Therefore, there is a need to accurately measure the delay in multimedia data transmission to enable the desired QoS.

### SUMMARY OF THE INVENTION

Accordingly, the present invention has been designed to solve the above and other problems occurring in the prior art and provides additional advantages, by providing an apparatus and method for quantitatively measuring a delay in multimedia data, such as an MPEG2-TS, in a multimedia data transmitting and receiving system.

One aspect of the present invention is to provide a method and apparatus for quantitatively measuring a delay in transmitting and receiving multimedia data by measuring a delay in data transmission, thereby enabling an evaluation of the system performance for a communication system.

In one embodiment, there is provided an apparatus for measuring a delay in the transmission of multimedia data in a multimedia data transmitting and receiving system according to communication environments, the apparatus comprising a transmitter generating and transmitting a counter information packet (CIP) by inserting the results of counting predetermined bits into the multimedia data using a first counter so as to measure the delay in the transmission of the multimedia data; and a receiver for receiving the CIP and measuring the delay in the transmission of multimedia data by comparing the counting results included in the CIP with the counting results received from the second counter.

In another embodiment, there is provided a method of measuring a delay in the transmission of multimedia data in a multimedia data transmitting and receiving system, the method comprising a transmitter for generating and transmitting a CIP required to measure the delay using a null packet of the multimedia data to be transmitted; computing an offset by setting a shortest path between the transmitter and the receiver of the multimedia data transmitting and receiving system, and measuring the delay by transmitting the CIP; computing the delay by installing a predetermined device in the shortest path between the transmitter and the receiver to measure the delay, and transmitting the CIP using the shortest path in which the predetermined device is located; and calibrating the delay by subtracting the offset from the computed delay.

### BRIEF DESCRIPTION OF THE DRAWINGS

The above features and advantages of the present invention will be more apparent from the following detailed description taken in conjunction with the accompanying drawings, in which:

FIG. 1 is a view illustrating an example of a multimedia data transmitting and receiving system;

FIG. 2 is a block diagram illustrating the construction of a multimedia data transmitter for obtaining information regarding a delay in the data transmission according to an embodiment of the present invention;

FIG. 3 is a block diagram illustrating the construction of a multimedia data receiver for obtaining information regarding a delay in the data transmission according to an embodiment of the present invention;

FIG. 4 is a view illustrating the structure of a CIP according to an embodiment of the present invention;

FIG. 5 is a flowchart illustrating a method of measuring a delay in the transmission of multimedia data according to an embodiment of the present invention;

FIG. 6A is a view illustrating a method of detecting an offset when measuring a delay in the transmission of multimedia data according to an embodiment of the present invention; and

FIG. 6B is a view illustrating a method of detecting a delay caused by a device under test (DUT) when measuring a delay in the transmission of the multimedia data according to an embodiment of the present invention.

### DETAILED DESCRIPTION

Embodiments of the present invention will be described in detail hereinafter with reference to the accompanying drawings. For the purposes of clarity and simplicity, a detailed description of known functions and configurations incorporated herein will be omitted to avoid making the subject matter of the present invention unclear.

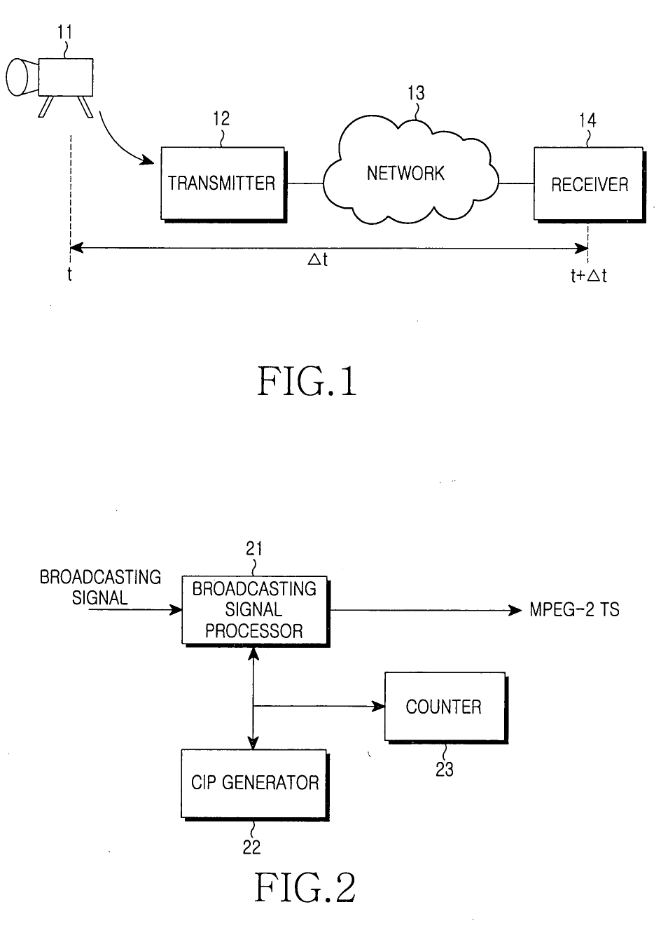

FIG. 1 illustrates whereto the embodiment of the present invention is applicable. The multimedia data transmitting and receiving system according to the present invention includes a camera 11 that generates a broadcasting signal, a transmitter 12 that transforms the broadcasting signal received from the camera 11 into an MPEG-2 TS and transmits the MPEG-2 TS, the receiver 14 that receives the MPEG-2 TS and inversely transforms it into the broadcasting signal, and the network 13 that connects the transmitter 12 to the receiver 14.

In operation, if the time that the broadcasting signal is received from the camera 11 is t, the time that the broadcasting signal is received by the receiver 14 becomes t+Δt, considering a delay Δt caused by the transmitter 12, the network 13, and the receiver 14. If the transmitter 12 inserts time information into multimedia data and transmits the multimedia data to the receiver 14, the receiver 14 computes the delay Δt using the time information, and obtains information regarding a delay caused by a device, e.g., a DUT, over a network including a system delay caused by the transmitter 12 and the receiver 14.

FIG. 2 is a block diagram illustrating a multimedia data transmitter according to an embodiment of the present invention. As shown, the multimedia data transmitter includes a broadcasting signal processor 21 that receives a broadcasting signal and, in turn, generates and transmits an MPEG-2 TS; a counter information packet (CIP) generator 22 receives the MPEG-2 TS from the broadcasting signal processor 21 and generates a CIP by inserting counter information obtained by counting predetermined bits into a payload of a null packet of the MPEG-2 TS; and a counter 23 that counts the predetermined bits and transmits the counter information, which is to be included in the CIP, to the CIP generator 22. Here, the counter information may indicate the predetermined bits to be 128 bits.

A method of generating a CIP according to an embodiment of the present invention is performed as follows: First, a packet identifier (PID) “0×1FFF” indicating a null packet of an MPEG-2 TS is replaced with a specific PID in a reserved region from 0×0002 to 0×000F to represent that the null packet is the CIP. Next, the CIP is obtained by generating the counter information of 128 bits based on a pulse signal received from the external counter 23 (27 MHz), then the counter information is inserted into the end (payload) of a header of the CIP at intervals of 100 ms.

FIG. 4 illustrates the construction of a CIP according to an embodiment of the present invention. As shown, the CIP is comprised of a CIP PID field 41 indicating the CIP, and a CIP field 42 including 128-bit counter information received from a counter for measuring the delay in data transmission.

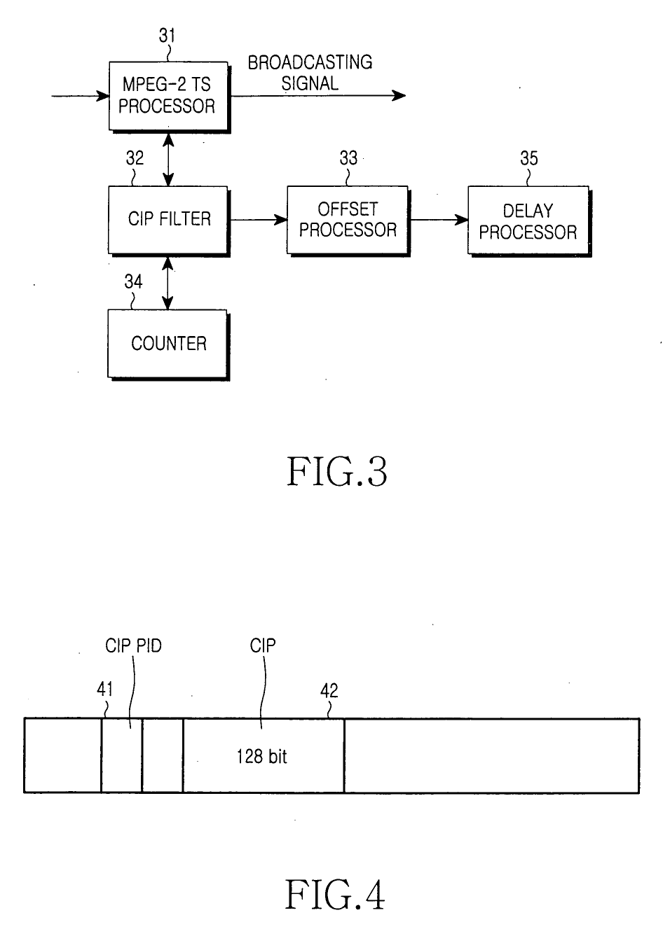

FIG. 3 is a block diagram illustrating the construction of a multimedia data receiver for obtaining information regarding the delay in data transmission according to an embodiment of the present invention.

Referring to FIG. 3, the multimedia data receiver includes an MPEG-2 TS processor 31 that receives an MPEG-2 TS and outputs a broadcasting signal, a CIP filter 32 that receives a CIP from the MPEG-2 TS processor 31 and restores it to a null packet of the MPEG-2 TS, a counter 34 that counts the predetermined bits of the MPEG-2 TS to obtain the counter information required to restore the CIP to the null packet, and the counter information is transmitted to the CIP filter 32, an offset processor 33 that stores an offset of a system delay for a precise calibration of the delay in data transmission, and a delay processor 35 that stores and provides an offset-compensated delay.

More specifically, 2-step operations are performed to measure the delay in data transmission using a receiver. The 2-step operations include detecting an offset of the delay caused by a multimedia data transmitting and receiving system in order to measure the delay in data transmission, and computing an actual delay caused by a DUT using the measured offset.

Specifically, in order to measure the offset of the delay caused by the multimedia data transmitting and receiving system, first, a shortest path between the transmitter and the receiver is set, and 128-bit CIPs are counted based on the pulse signal received from the external counter 34 (27 MHz) of the receiver, starting from the instant when a first CIP begins coming into the receiver. Next, the difference between the counting result and a value included in the payload of the CIP is computed, the difference is set to an offset, and the offset is stored in the multimedia data transmitting and receiving system.

Similarly, when a DUT is located between the transmitter and the receiver, delay in data transmission caused by the DUT is measured using the difference between a counting result received from a counter and a value stored in the payload of a CIP. In this case, the previously obtained offset is further subtracted from the difference for delay calibration.

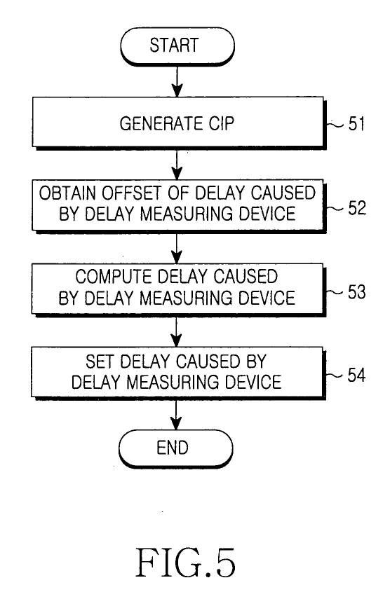

FIG. 5 is a flowchart illustrating a method of measuring a delay in the transmission of multimedia data of a multimedia system according to an embodiment of the present invention.

Referring to FIG. 5, first, a transmitter of the multimedia data transmitting and receiving system generates and transmits a CIP required to measure the delay using a null packet of the MPEG-2 TS (51).

Then, an offset of delay due to a delay measuring device is measured by setting a shortest path between the transmitter and the receiver and measuring the delay of transmission of the multimedia data by transmitting the CIP (52).

Next, the delay due to the delay-measuring device such as the DUT is computed by installing the delay-measuring device in the shortest path between the transmitter and the receiver, and transmitting the CIP using the path (53). Delay calibration is performed by subtracting the offset value from the computed delay.

Thereafter, the delay caused by the delay-measuring device, such as the DUT, is set (54).

Alternatively, a delay in the transmission of multimedia data may be measured in a software manner using the transmitter and the receiver, or measured by embodying a complex programmable logic device (CPLD) or a field programmable gate array (FPGA) in a hardware manner, thereby enabling more precise resolution.

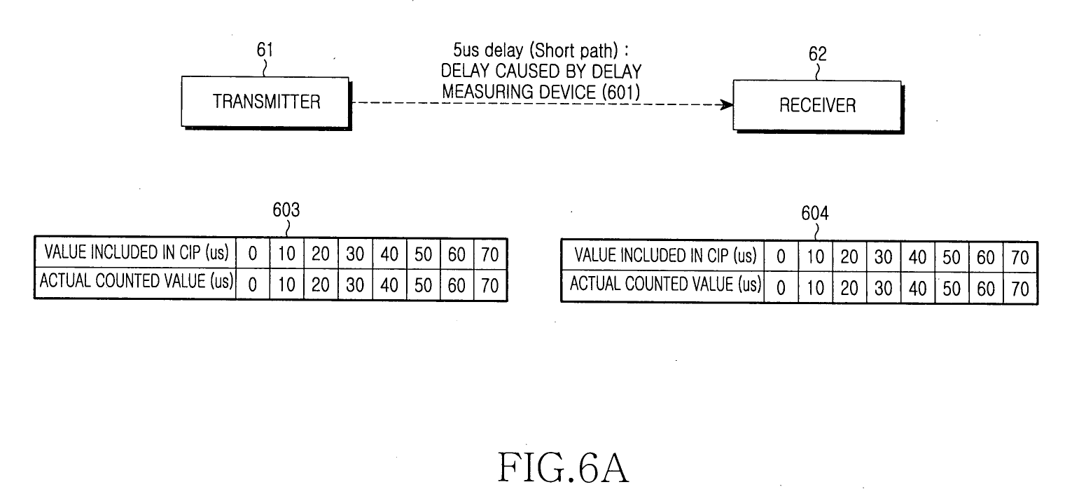

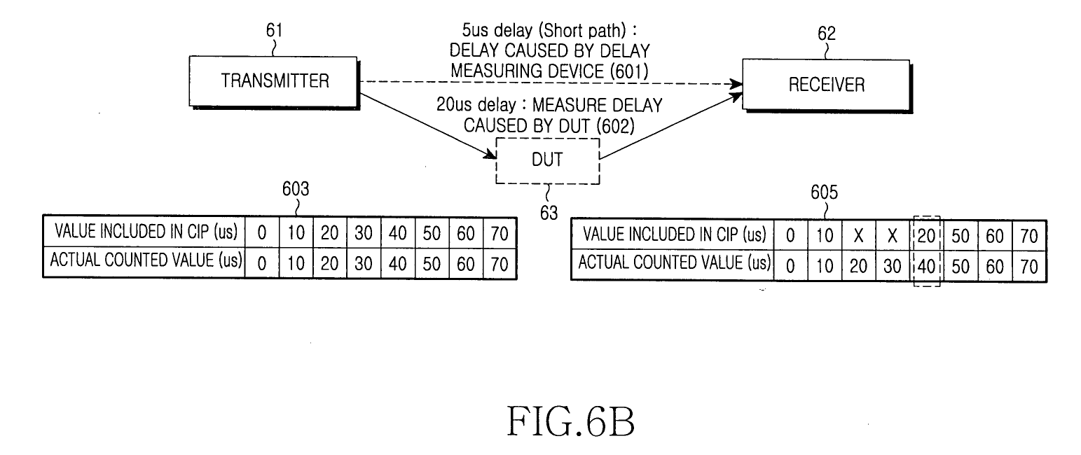

FIG. 6A illustrates a method of detecting an offset when measuring delay in the transmission of multimedia data in a multimedia data transmitting and receiving system, according to an embodiment of the present invention.

Referring to FIG. 6A, when the multimedia data is transmitted from a transmitter 61 to a receiver 62, a shortest path between the transmitter 61 and the receiver 62 is set to measure the delay in the transmission of multimedia data which is caused by a delay measuring device (601). In this example, it is assumed that the delay in the transmission of the multimedia data is set to 5 μs.

Here, in a CIP 603 transmitted from the transmitter 61, actual counted values are equal to the values included in the CIP. In a CIP 604 input to the receiver 62 considering a delay offset, actual counted values are also equal to the values included in the CIP 604.

FIG. 6B illustrates a method of detecting a delay in the transmission of multimedia, which is caused by a delay-measuring device, such as a DUT 63 according to an embodiment of the present invention.

Referring to FIG. 6B, when the multimedia data is transmitted from a transmitter 61 to a receiver 62, first, a shortest path between the transmitter 61 and the receiver 62 is set to measure the delay caused by the DUT 63 (601). Next, an offset of the delay caused by the DUT 63 is measured. In this example, it is assumed that the delay caused by the DUT is 5 μs.

When the DUT 63 is located between the transmitter 61 and the receiver 62, the delay caused by the DUT 62 is measured by computing the difference between counting results in a CIP 603 transmitted from the transmitter 61 and a CIP 605 input to the receiver 62 while considering the offset (602).

That is, as illustrated in FIG. 6A, when the offset of the delay of 5 μs is set, the CIP received by the receiver 62 reveals that the counting results received from the receiver 62 are respectively equal to the values included in the CIP. Thus, as illustrated in FIG. 6B, delay in transmission of the multimedia data, caused by the DUT 63, is determined by the difference between a counting result received from the receiver 62 and a value included in the CIP 605. In this example, it is assumed that the delay caused by the DUT is 20 μs.

As described above, the present invention provides an apparatus and method for quantitatively measuring a delay caused when an MPEG2-TS is transmitted from a transmitter, passes through a specified system, and then is received by a receiver using a counter information packet (CIP). Accordingly, it is possible to develop a broadcasting system that requires data to be transmitted and received in real time, such that the delay in data transmission is minimized, thereby improving the performance of the broadcasting system.

A method of measuring a delay in the transmission of multimedia in a multimedia data transmitting and receiving system according to the present invention may be implemented as a computer readable program and stored in a recording medium, such as a CD-ROM, a RAM, a floppy disk, a hard disc, and an optomagnetic disc.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. An apparatus for measuring a delay during a transmission of multimedia data in a multimedia system, the apparatus comprising:
a transmitter for transmitting a counter information packet (CIP) including counting results of predetermined bits, using a first counter so as to measure a delay in the transmission of multimedia data; and
a receiver for measuring the delay in the transmission of multimedia data by comparing the counting results included in the CIP with counting results from a second counter.

2. The apparatus as claimed in claim 1, wherein the multimedia data is a moving picture experts group (MPEG)-2 transform stream (TS).

3. The apparatus as claimed in claim 2, wherein the transmitter comprises:
a broadcasting signal processor receiving a broadcasting signal from an external broadcasting apparatus and transmitting the MPEG-2 TS corresponding the broadcasting signal; and
a CIP generator coupled to the broadcasting signal processor for generating the CIP by inserting the counting results of the predetermined bits into a payload of a null packet of the MPEG-2 TS,
wherein the first counter counts the predetermined bits and transmitting the counting result in the CIP to the CIP generator.

4. The apparatus as claimed in claim 3, wherein the receiver comprises:
an MPEG-2 TS processor for receiving the MPEG-2 TS and outputting the broadcasting signal;
a CIP filter for receiving the CIP from the MPEG-2 TS processor and inversely transforming the CIP into the null packet; and
an offset processor storing an offset of the delay caused by the multimedia system for performing a precise delay calibration,
wherein the second counter transmits the null packet to the CIP filter.

5. The apparatus as claimed in claim 4, further comprising a delay processor storing and providing the offset-processed delay caused according to the communication environments.

6. The apparatus as claimed in claim 4, wherein the offset is determined by setting a communication environment with a shortest path between the transmitter and the receiver, and comparing the counting results in the payload of the CIP received by the receiver with the counting results received from the second counter.

7. The apparatus as claimed in claim 1, wherein the CIP is obtained by transforming a packet identifier value of the null packet into a predetermined specific value to indicate that the packet is the CIP.

8. The apparatus as claimed in claim 7, wherein the predetermined bits are 128 bits.

9. A method of measuring a delay during a transmission of multimedia data in a multimedia system, the method comprising:
transmitting a counter information packet (CIP) required to measure the delay using a null packet of the multimedia data to be transmitted;
computing an offset by setting a shortest path between a transmitter and a receiver and measuring the delay;
computing the delay by installing a predetermined device in the shortest path between the transmitter and the receiver and transmitting the CIP using the shortest path in which the predetermined device is located; and
calibrating the delay by subtracting the offset from the computed delay.
